(19) United States
(12) Patent Application Publication
(10) Pub. No.: US 2025/0150913 A1
(43) Pub. Date: May 8, 2025

(54) DISPLAY DEVICE AND OPERATING METHOD THEREOF

(71) Applicant: LG ELECTRONICS INC., Seoul (KR)

(72) Inventors: Jeong Hwan KWON, Seoul (KR); Hyo Jeong JEONG, Seoul (KR); Sang Hun KIM, Seoul (KR)

(73) Assignee: LG ELECTRONICS INC., Seoul (KR)

(21) Appl. No.: 18/627,688

(22) Filed: Apr. 5, 2024

(30) Foreign Application Priority Data
Nov. 8, 2023 (KR) 10-2023-0153384

(51) Int. Cl. H04W 36/00; G06F 3/16; H04W 36/30; H04W 36/32; H04W 84/18

(52) U.S. Cl. CPC H04W 36/035; G06F 3/165; H04W 36/302; H04W 36/322; H04W 84/18

(57) ABSTRACT

A display device includes a display, a Bluetooth communication circuit configured to communicate with an audio output device through Bluetooth, a WiFi circuit configured to WiFi communicate with an external device, and a controller configured to obtain a screen link command while transmitting audio data to the audio output device through the Bluetooth communication circuit, determine whether to perform handover to switch Bluetooth connection with the audio output device to the external device depending on the obtained screen link command, and stop connection with the audio output device based on determining to perform the handover.

### CROSS-REFERENCE TO RELATED APPLICATION

This application is the KOREAN PATENT Application No. 10-2023-0153384, filed on Nov. 8, 2023, all of which are hereby expressly incorporated by reference into the present application.

### TECHNICAL FIELD

The present disclosure relates to a display device, and more particularly, to a display device for automatically switching connection with an audio output device.

### BACKGROUND ART

Digital TV services using wired or wireless communication networks have become popular. Digital TV services may provide a variety of services that may not be provided by existing analog broadcasting services.

For example, an Internet protocol television (IPTV) and a smart TV service, which are types of digital TV services, provide interactivity that allows users to actively select the type and viewing time of program to watch. The IPTV and the smart TV service may also provide various additional services, such as Internet search, home shopping, and online games, based on this interactivity.

A conventional TV may be connected to a Bluetooth device and transmit audio to the Bluetooth device, and a user listens to the audio output from the TV through the Bluetooth device.

A user has a need to watch an image on a first TV located in a main room and then moves to a second TV located in another room to watch the image.

In this situation, the Bluetooth device needs to be handed over from the first TV to the second TV, but the Bluetooth device does not reconnect to a new device until it is disconnected from the first connected device, which causes an inconvenient situation.

In other words, existing users have an inconvenience of having to first disconnect the Bluetooth connection between the connected first TV and the Bluetooth device, and then connect the Bluetooth device to the second TV.

In addition, when connecting the Bluetooth device to the second TV, there is an inconvenience of having to update voice settings for the existing Bluetooth device on the second TV.

### DISCLOSURE

### Technical Problem

An object of the present disclosure is to connect a Bluetooth device seamlessly by automatically performing a handover process of the Bluetooth device.

An object of the present disclosure is to automatically performing voice settings for a Bluetooth device a handover process of the Bluetooth device.

### Technical Solution

According to an embodiment of the present disclosure, a display a device includes display, a Bluetooth communication circuit configured to communicate with an audio output device through Bluetooth, a WiFi circuit configured to WiFi communicate with an external device, and a controller configured to obtain a screen link command while transmitting audio data to the audio output device through the Bluetooth communication circuit, determine whether to perform handover to switch Bluetooth connection with the audio output device to the external device depending on the obtained screen link command, and stop connection with the audio output device based on determining to perform the handover.

According to an embodiment of the present disclosure, an operating method of a display device includes obtaining a screen link command while transmitting audio data to an audio output device through a Bluetooth communication circuit, determining whether to perform handover to switch Bluetooth connection with the audio output device to the external device depending on the obtained screen link command, and stopping connection with the audio output device based on determining to perform the handover.

### Advantageous Effects

According to an embodiment of the present disclosure, even if a Bluetooth device is connected to only one TV, when a room to room (R2R) is used, the Bluetooth device may be automatically connected to different TVs.

In addition, a user may be provided with user experience seamlessly by matching voice setting values for a Bluetooth device in different TVs to the same value.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view of utilizing a remote control device according to an embodiment of the present disclosure.

FIG. 5 is a sequence diagram for explaining an operating method of a system according to an embodiment of the present disclosure.

FIGS. 6A and 6B are diagrams for explaining a procedure of determining handover through a pop-up window for handover.

FIG. 7A is a diagram for determining handover based on an RSSI according to an embodiment of the present disclosure and FIG. 7B is a diagram for determining an example of outputting a notification for inducing movement of an audio output device according to a screen connection command.

FIG. 8 is a diagram for explaining a process of detecting a handover situation based on information received from a second display device according to an embodiment of the present disclosure.

FIG. 9 is a diagram for explaining a scenario for performing handover according to an embodiment of the present disclosure.

### BEST MODE

Hereinafter, embodiments relating to the present disclosure will be described in detail with reference to the drawings. The suffixes “module” and “unit” for components used in the description below are assigned or mixed in consideration of easiness in writing the specification and do not have distinctive meanings or roles by themselves.

A display device according to an embodiment of the present disclosure is, for example, an intelligent display device that adds a computer supporting function to a broadcast receiving function, and may have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS may be used.

Accordingly, since various applications are freely added or deleted on a general purpose OS kernel, a display device described herein, for example, may perform various user-friendly functions. The display device, in more detail, may be a network TV, Hybrid Broadcast Broadband TV (HBBTV), smart TV, light-emitting diode (LED) TV, organic light-emitting diode (OLED) TV, and so on and in some cases, may be applied to a smartphone.

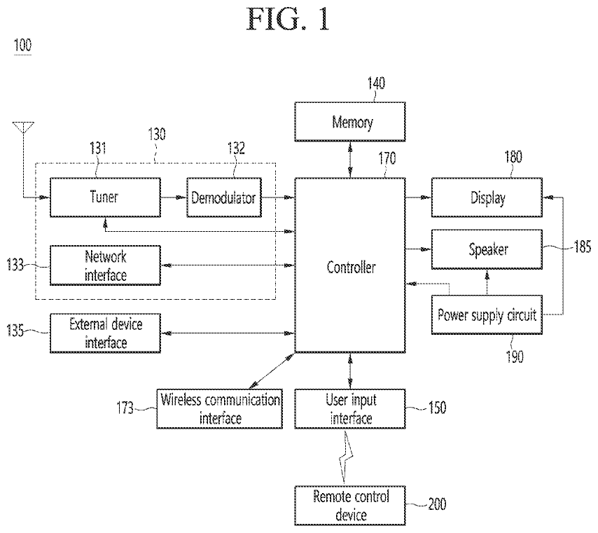

FIG. 1 is a block diagram illustrating a configuration of a display device according to an embodiment of the present disclosure.

Referring to FIG. 1, a display device 100 may include a broadcast receiver 130, an external device interface 135, a storage 140, a user interface 150, a controller 170, a wireless communication interface 173, a display 180, an audio output interface 185, and a power supply 190.

The broadcast receiver 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulator 132 may divide the received broadcast signals into video signals, audio signals, and broadcast program-related data signals, and may restore the divided video signals, audio signals, and data signals into the form capable of being output.

The external device interface 135 may receive an application or an application list in an adjacent external device, and may transmit the application or the application list to the controller 170 or the storage 140.

The external device interface 135 may provide a connection path between the display device 100 and the external device. The external device interface 135 may receive at least one an image or audio output from the external device that is wirelessly or wiredly connected to the display device 100, and may transmit the image and/or the audio to the controller 170. The external device interface 135 may include a plurality of external input terminals. The plurality of external input terminals may include an RGB terminal, at least one High Definition Multimedia Interface (HDMI) terminal, and a component terminal.

An image signal of the external device input through the external device interface 135 may be output through the display 180. A voice signal of the external device input through the external device interface 135 may be output through the audio output interface 185.

An external device connectable to the external device interface 135 may be one of a set-top box, a Blu-ray player, a DVD player, a game console, a sound bar, a smartphone, a PC, a USB memory, and a home theater system, but this is just exemplary.

The network interface 133 may provide an interface for connecting the display device 100 to a wired/wireless network including an Internet network. The network interface 133 may transmit or receive data to or from another user or another electronic device through an accessed network or another network linked to the accessed network.

In addition, some content data stored in the display device 100 may be transmitted to a user or an electronic device, which is selected from other users or other electronic devices preregistered in the display device 100.

The network interface 133 may access a predetermined webpage through an accessed network or another network linked to the accessed network. That is, the network interface 133 may transmit or receive data to or from a corresponding server by accessing a predetermined webpage through the network.

The network interface 133 may receive content or data provided from a content provider or a network operator. That is, the network interface 133 may receive content, such as movies, advertisements, games, VODs, and broadcast signals, which are provided from the content provider or the network operator, and information relating thereto through the network.

In addition, the network interface 133 may receive firmware update information and update files provided from the network operator, and may transmit data to the Internet or content provider or the network operator.

The network interface 133 may select and receive a desired application among applications open to the air, through the network.

The storage 140 may store signal-processed image, voice, or data signals stored by a program in order for each signal processing and control in the controller 170.

In addition, the storage 140 may perform a function for temporarily storing image, voice, or data signals output from the external device interface 135 or the network interface 133, and may store information on a predetermined image through a channel memory function.

The storage 140 may store an application or an application list input from the external device interface 135 or the network interface 133.

The display device 100 may play content files (e.g., video files, still image files, music files, document files, application files, etc.) stored in the storage 140, and may provide the content files to a user.

The user input interface 150 may transmit signals input by a user to the controller 170, or may transmit signals from the controller 170 to a user. For example, the user input interface 150 may receive or process control signals such as power on/off, channel selection, and screen setting from a remote control device 200 or transmit control signals from the controller 170 to the remote control device 200 according to various communication methods such as Bluetooth, Ultra Wideband (WB), ZigBee, Radio Frequency (RF), and IR communication methods.

In addition, the user input interface 150 may transmit, to the controller 170, control signals input from local keys (not shown) such as a power key, a channel key, a volume key, and a setting key.

Image signals that are image-processed by the controller 170 may be input to the display 180 and displayed as images corresponding to the image signals. In addition, image signals that are image-processed by the controller 170 may be input to an external output device through the external device interface 135.

Voice signals processed by the controller 170 may be output to the audio output interface 185. In addition, voice signals processed by the controller 170 may be input to the external output device through the external device interface 135.

Additionally, the controller 170 may control overall operations of the display device 100.

In addition, the controller 170 may control the display device 100 by a user command or an internal program input through the user input interface 150, and may access the network to download a desired application or application list into the display device 100.

The controller 170 may output channel information selected by a user together with the processed image or voice signals through the display 180 or the audio output interface 185.

In addition, the controller 170 may output image signals or voice signals of an external device such as a camera or a camcorder, which are input through the external device interface 135, through the display 180 or the audio output interface 185, according to an external device image playback command received through the user input interface 150.

Moreover, the controller 170 may control the display 180 to display images, and may control the display 180 to display broadcast images input through the tuner 131, external input images input through the external device interface 135, images input through the network interface, or images stored in the storage 140. In this case, an image displayed on the display 180 may be a still image or video and also may be a 2D image or a 3D image.

Additionally, the controller 170 may play content stored in the display device 100, received broadcast content, and external input content input from the outside, and the content may be in various formats such as broadcast images, external input images, audio files, still images, accessed web screens, and document files.

Moreover, the wireless communication module 173 may perform wired or wireless communication with an external device. The wireless communication module 173 may perform short-range communication with an external device. For this, the wireless communication interface 173 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication module 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication module 173 may detect (or recognize) a wearable device capable of communication around the display device 100.

Furthermore, if the detected wearable device is a device authenticated to communicate with the display device 100, the controller 170 may transmit at least part of data processed in the display device 100 to the wearable device through the wireless communication interface 173. Therefore, a user of the wearable device may use the data processed by the display device 100 through the wearable device.

The display 180 may convert image signals, data signals, or on-screen display (OSD) signals, which are processed in the controller 170, or images signals or data signals, which are received in the external device interface 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component or one component may be divided into two or more components and configured. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface 133 or the external device interface 135 and play them without including the tuner 131 and the demodulator 132.

For example, the display device 100 may be divided into an image processing device such as a set-top box for receiving broadcast signals or contents according to various network services and a content playback device for playing contents input from the image processing device.

In this case, an operating method of a display device according to an embodiment of the present disclosure described below may be performed by one of the display device described with reference to FIG. 1, an image processing device such as the separated set-top box, and a content playback device including the display 180 and the audio output interface 185.

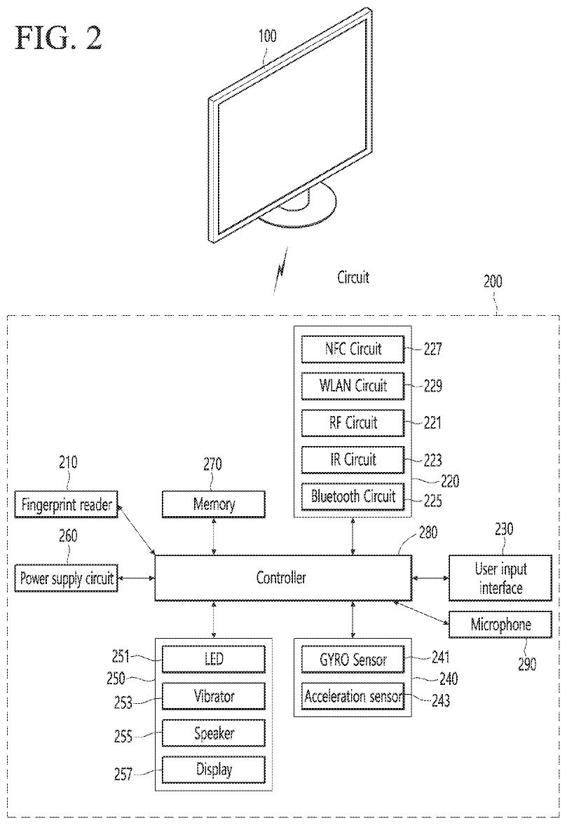

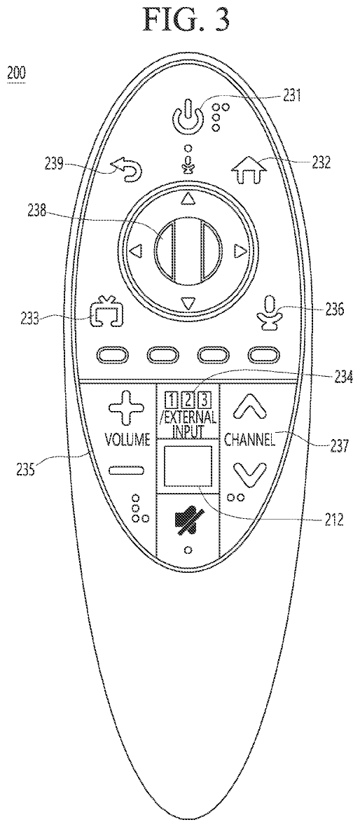

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognizer 210, a wireless communication module 220, a user input interface 230, a sensor module 240, an output interface 250, a power supply 260, a storage 270, a controller 280, and a voice acquirer 290.

Referring to FIG. 2, the wireless communication interface 220 transmits/receives signals to/from an arbitrary any one of display devices according to the above-mentioned embodiments of the present disclosure.

The remote control device 200 may include a radio module 221 transmitting frequency (RF) capable of or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication module 220.

Moreover, the remote control device 200 may receive signals transmitted from the display device 100 through the RF module 221 and if necessary, may transmit a command for power on/off, channel change, and volume change to the display device 100 through the IR module 223.

The user input interface 230 may be configured with a keypad, a button, a touch pad, or a touch screen. A user may operate the user input interface 230 to input a command relating to the display device 100 to the remote control device 200. If the user input interface 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display device 100.

The home button 232 may be a button for moving to the home screen of the display device 100.

The live button 233 may be a button for displaying live broadcast programs.

The external input button 234 may be a button for receiving an external input connected to the display device 100.

The volume control button 235 may be a button for controlling a volume output from the display device 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input interface 230 includes a touch screen, a user may touch a soft key of the touch screen to input a command relating to the display device 100 to the remote control device 200. In addition, the user input interface 230 may include various kinds of input interfaces operable by a user, for example, a scroll key and a jog key, and this embodiment does not limit the scope of the present disclosure.

The sensor module 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display 180 of the display device 100.

The output interface 250 may output image or voice signals in response to the operation of the user input interface 235, or may output image or voice signals corresponding to signals transmitted from the display device 100.

A user may recognize whether the user input interface 235 is operated or the display device 100 is controlled through the output interface 250.

For example, the output interface 250 may include an LED module 251 for flashing, a vibration module 253 for generating vibration, a sound output module 255 for outputting sound, or a display module 257 for outputting an image, if the user input interface 235 is manipulated or signals are transmitted/received to/from the display device 100 through the wireless communication interface 225.

Additionally, the power supply 260 supplies power to the remote control device 200 and if the remote control device 200 does not move for a predetermined time, stops the power supply, so that power waste may be reduced.

The power supply 260 may resume the supply of power if a predetermined key provided at the remote control device 200 is operated.

The storage 270 may store various kinds of programs and application data required to control or operate the remote control device 200.

If the remote control device 200 transmits/receives signals wirelessly through the display device 100 and the RF module 221, the remote control device 200 and the display device 100 transmits/receives signals through a predetermined frequency band.

The controller 280 of the remote control device 200 may store, in the storage 270, information on a frequency band for transmitting/receiving signals to/from the display device 100 paired with the remote control device 200 and refer to it.

The controller 280 controls general matters relating to the control of the remote control device 200. The controller 280 may transmit a signal corresponding to a predetermined key operation of the user input interface 235 or a signal corresponding to the movement of the remote control device 200 sensed by the sensor module 240 to the display device 100 through the wireless communication module 225.

In addition, the voice acquirer 290 of the remote control device 200 may acquire voice.

The voice acquirer 290 may include at least one microphone and acquire voice through the microphone.

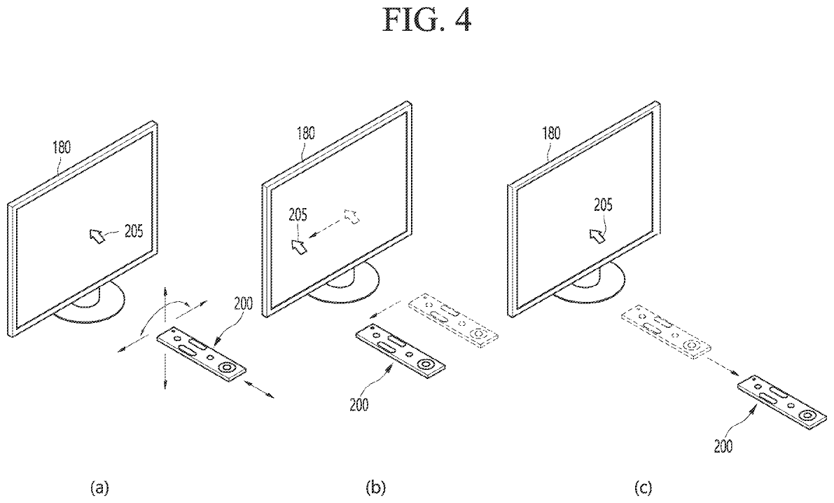

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display 180.

A user may move or rotate the remote control device 200 vertically or horizontally. The pointer 205 displayed on the display 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display 180. Thus, a selected region in the display 180 corresponding to the pointer 205 may be zoomed in and displayed in an enlarged size.

On the other hand, if a user moves the remote control device 200 close to the display 180, a selection area in the display 180 corresponding to the pointer 205 may be zoomed out and displayed in a reduced size.

On the other hand, if the remote control device 200 is moved away from the display 180, a selection area may be zoomed out and if the remote control device 200 is moved closer to the display 180, a selection area may be zoomed in.

Additionally, if a specific button in the remote control device 200 is pressed, recognition of a vertical or horizontal movement may be excluded. That is, if the remote control device 200 is moved away from or closer to the display 180, the up, down, left, or right movement may not be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display 180 and also may be displayed in correspondence to a plurality of points such as a line and a surface.

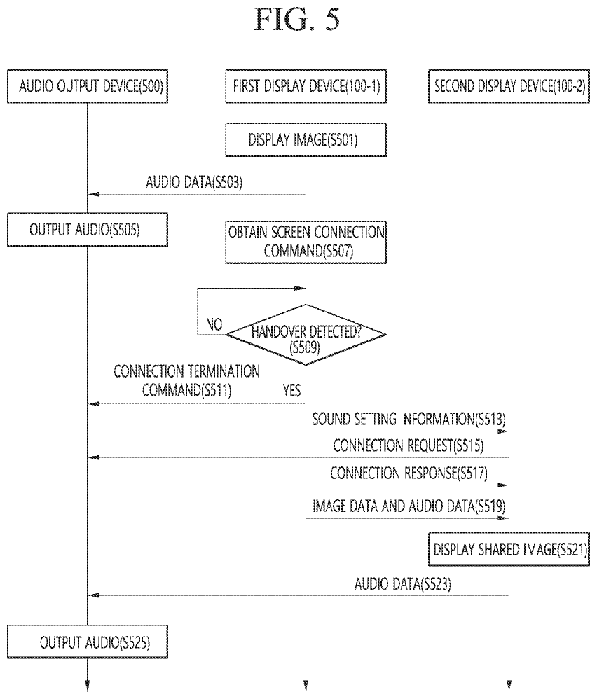

FIG. 5 is a sequence diagram for explaining an operating method of a system according to an embodiment of the present disclosure.

Referring to FIG. 5, the system according to an embodiment of the present disclosure may include an audio output device 500, a first display device 100-1, and a second display device 100-2.

Each of the first display device 100-1 and the second display device 100-2 may include all components of the display device 100 shown in FIG. 1.

That is, each of the first display device 100-1 and the second display device 100-2 may be an example of the display device 100.

The audio output device 500 is a device that supports Bluetooth communication and may be an electronic device such as a headset or earphones for outputting audio.

As necessary, the first display device 100-1 is a display device and the second display device 100-2 may be referred to as an external device.

The audio output device 500 may be connected to the first display device 100-1 or the second display device 100-2 through Bluetooth communication.

The first display device 100-1 and the second display device 100-2 may be connected to each other via Wi-Fi through an access point (AP).

The first display device 100-1 and the second display device 100-2 may be connected P2P to each other through the Wi-Fi direct standard.

Referring to FIG. 5, a controller 170 of the first display device 100-1 display an image on the display 180 (S501).

The controller 170 of the first display device 100-1 transmit audio data to the audio output device 500 through a Bluetooth circuit provided in a wireless communication interface 173 (S503), and the audio output device 500 output audio based on the received audio data (S505).

In other words, the user currently listens to audio corresponding to an image through the audio output device 500 while watching the image through the first display device 100-1.

The controller 170 of the first display device 100-1 may obtain a screen connection command (S507) and determine whether a current situation is a handover situation according to the obtained screen connection command (S509).

According to an embodiment, the screen connection command may be a command to display the image displayed by the first display device 100-1 through the second display device 100-2.

The first display device 100-1 may obtain the screen connection command while displaying an image.

When the first display device 100-1 and the second display device 100-2 are located in different rooms, the screen connection command may be a room to room (R2R) command for displaying the image that is currently displayed on the first display device 100-1, on the second display device 100-2.

According to an embodiment, the controller 170 of the first display device 100-1 may receive the screen connection command from the remote control device 200.

According to another embodiment, the controller 170 of the first display device 100-1 may receive the screen connection command from the second display device 100-2.

According to an embodiment, handover may be an action that switches the connection with the audio output device 500 from the first display device 100-1 to the second display device 100-2.

According to an embodiment, the controller 170 of the first display device 100-1 may detect a handover situation based on a user input.

According to another embodiment, the controller 170 may detect whether a current situation is handover situation based on a first received signal strength indicator (RSSI) between the audio output device 500 and the first display device 100-1 and a second RSSI between the audio output device 500 and the second display device 100-2.

According to another embodiment, the controller 170 may determine whether the current situation is a handover situation based on connectivity information received from the second display device 100-2.

This will be described with reference to the following diagrams.

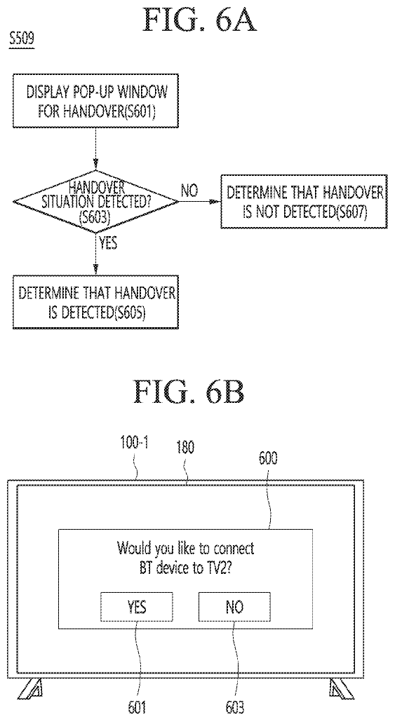

FIGS. 6A and 6B are diagrams for explaining a procedure of determining handover through a pop-up window for handover.

Referring to FIGS. 6A and 6B, the controller 170 of the first display device 100-1 may display a pop-up window 600 for handover on the display 180 upon receiving the screen connection command (S601).

The pop-up window 600 may be a window asking whether to connect the audio output device 500 (BT device) to the second display device 100-2 (TV2).

That is, the pop-up window 600 may be a window to inquire about handover.

The pop-up window 600 may include a confirmation button 601 and a reject button 603.

The controller 170 of the first display device 100-1 may determine whether to receive a confirmation command approving handover through the pop-up window 600 (S603).

The controller 170 of the first display device 100-1 may detect that the handover situation is detected based on that a command for selecting the confirmation button 601 provided in the pop-up window 600 is received (S605).

The controller 170 of the first display device 100-1 may determine that the handover situation is not detected based on that a command for selecting the reject button 603 provided in the pop-up window 600 is received (S607).

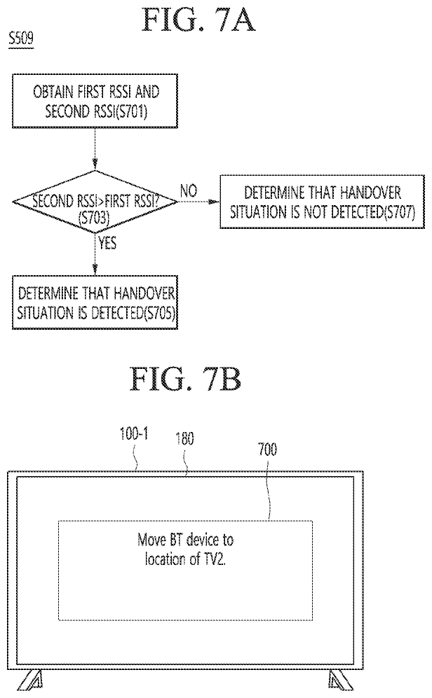

Then, FIGS. 7A and 7B will be described.

FIG. 7A is a diagram for determining handover based on an RSSI according to an embodiment of the present disclosure. FIG. 7B is a diagram for determining an example of outputting a notification for inducing movement of an audio output device according to a screen connection command.

The controller 170 of the first display device 100-1 may obtain the first RSSI between the audio output device 500 and the first display device 100-1 and the second RSSI between the audio output device 500 and the second display device 100-2 (S701).

The controller 170 of the first display device 100-1 may directly measure the first RSSI and may receive the second RSSI from the second display device 100-2.

When the second RSSI is greater than the first RSSI (S703), the controller 170 of the first display device 100-1 may determine that the handover situation is detected (S705).

The controller 170 of the first display device 100-1 may determine that the audio output device 500 is located closer to the second display device 100-2 than the first display device 100-1.

In this situation, the user may hold the audio output device 500 and move from a space in which the first display device 100-1 is located to a space in which the second display device 100-2 is located.

When the second RSSI is less than the first RSSI (S703), the controller 170 of the first display device 100-1 may determine that the handover situation is not detected (S707).

The controller 170 of the first display device 100-1 may display a guide 700 for inducing movement of the audio output device 500 to the second display device 100-2 on the display 180 upon receiving the screen connection command, as shown in FIG. 7B.

The guide 700 may also be displayed on the second display device 100-2.

When the handover situation is detected but it is not possible to perform handover, the controller 170 of the first display device 100-1 may display the guide 700 for inducing movement of the audio output device 500, on the display 180.

When handover is determined to be performed but is not capable of being performed, the controller 170 of the first display device 100-1 may display the guide 700 for inducing movement of the audio output device 500, on the display 180.

The user may move the audio output device 500 to a point at which the second display device 100-2 is located, through the guide 700.

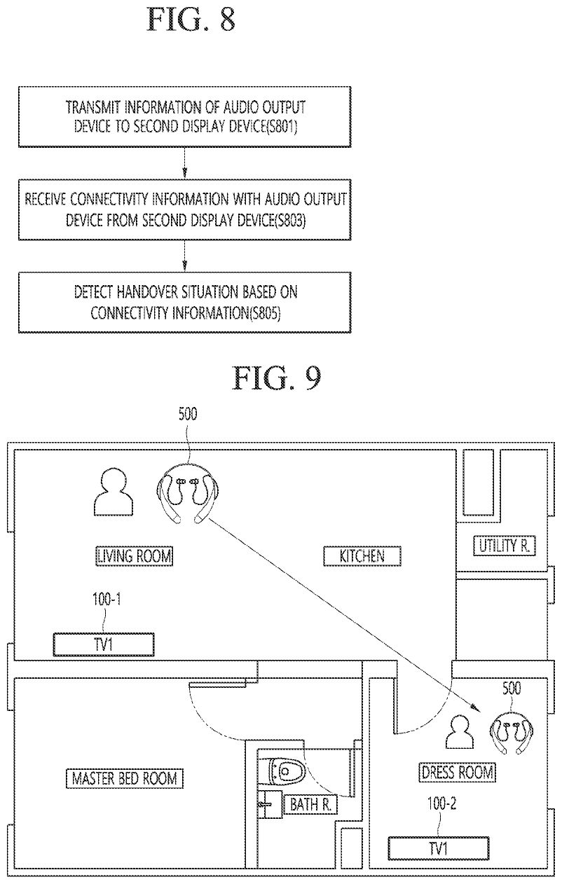

FIG. 8 is a diagram for explaining a process of detecting a handover situation based on information received from a second display device according to an embodiment of the present disclosure.

The controller 170 of the first display device 100-1 may transmit information of the audio output device 500 to the second display device 100-2 through the wireless communication interface 173 upon receiving the screen connection command (S801).

The information of the audio output device 500 may include one or more of a name of the audio output device 500 and a MAC address of the audio output device 500.

According to another embodiment, the controller 170 of the first display device 100-1 may transmit the information of the audio output device 500 to a server, and the second display device 100-2 may receive the information of the audio output device 500 from the server.

The controller 170 of the first display device 100-1 may receive connectivity information indicating whether the audio output device 500 is to be connected from the second display device 100-2 through the wireless communication interface 173 (S803).

The second display device 100-2 may determine whether the audio output device 500 is to be connected, based on a connected state of the second display device 100-2 and the information of the audio output device 500.

The second display device 100-2 may determine whether a state thereof is capable of Bluetooth connection. When the second display device 100-2 is powered on and less than the limited number of Bluetooth devices connected to the second display device 100-2 are connected, the second display device 100-2 may determine that the state thereof is a state in which Bluetooth connection is possible.

When the second display device 100-2 determines that a connected state thereof is a Bluetooth connectable state and the audio output device 500 is determined to be a device capable of supporting Bluetooth, it is determined that connection with the audio output device 500 is possible.

The second display device 100-2 may transmit connectivity information indicating that it is possible or not possible connect the audio output device 500, to the first display device 100-1.

The connectivity information may include information indicating that less than the limited number of Bluetooth devices connected to the second display device 100-2 are connected.

The controller 170 of the first display device 100-1 may detect the handover situation based on the connectivity information received from the second display device 100-2 (S805).

The controller 170 of the first display device 100-1 may detect the current situation as the handover situation when the connectivity information includes information indicates that a connection is possible with the audio output device 500 or includes information indicating a connectivity state.

The information indicating a connectivity state may include one or more of numbers or letters.

FIG. 5 will be described again.

When determining that the current situation is the handover situation, the controller 170 of the first display device 100-1 may transmit a connection termination command to terminate Bluetooth connection with the audio output device 500 through a Bluetooth circuit (S511).

The controller 170 of the first display device 100-1 may terminate Bluetooth connection with the audio output device 500 through a Bluetooth circuit upon determining handover.

After terminating Bluetooth connection with the audio output device 500, the controller 170 of the first display device 100-1 may display a message indicating that Bluetooth connection with the audio output device 500 is terminated, on the display 180.

Simultaneously, the controller 170 of the first display device 100-1 may transmit a handover request requesting connection to the audio output device 500 to the second display device 100-2.

Upon determining that the current situation is the handover situation, the controller 170 of the first display device 100-1 may transmit sound setting information of the audio output device 500 to the second display device 100-2 through the wireless communication interface 173 (S513).

Sound setting information of the audio output device 500 may include one or more of sound effect information, audio delay information, or audio volume information.

The sound effect information may include Bluetooth equalizer setting information and Bluetooth surround setting information.

The audio delay information may include a delay time of audio received from the first display device 100-1 by the audio output device 500.

The audio volume information may include an absolute volume (ABS) of the audio output device 500 and sound (PCM) transmitted from the first display device 100-1.

The controller 170 of the first display device 100-1 may transmit the sound setting information to the second display device 100-2 to also apply the sound setting information of the audio output device 500 to the second display device 100-2 without change.

The controller 170 of the first display device 100-1 may also transmit the sound setting information and a setting command requesting sound settings for the audio output device 500 according to the sound setting information, to the second display device 100-2.

The second display device 100-2 may set sound factors according to the received sound setting information.

When there is a sound effect with the same name in the received sound effect information, the second display device 100-2 may be set to a sound effect with the corresponding name.

The second display device 100-2 may be set to a default sound effect or a similar sound effect when there is no sound effect of the same name in the received sound effect information.

The second display device 100-2 may set an audio delay time based on the audio delay information.

The second display device 100-2 may set the ABS and the PCM based on the audio volume information.

The controller 170 of the second display device 100-2 may transmit a connection request to the audio output device 500 through a Bluetooth circuit (S515) and receive a connection response from the audio output device 500 (S517).

The audio output device 500 may terminate Bluetooth connection with the first display device 100-1 and switch the mode into a pairing mode.

The audio output device 500 may receive the connection request for Bluetooth connection from the second display device 100-2 and transmit a connection response that allows connection to the second display device 100-2 in response to the connection request.

As the audio output device 500 and the second display device 100-2 are connected to each other via Bluetooth, the controller 170 of the first display device 100-1 may transmit image data and audio data to the second display device 100-2 through WiFi circuit of the wireless communication interface 173 (S519).

The first display device 100-1 may transmit image data and audio data corresponding to an image that is currently displayed by the first display device 100-1, to the second display device 100-2.

In this case, the first display device 100-1 may stop displaying the image.

The controller 170 of the second display device 100-2 may display a shared image on the display 180 based on the image data received from the first display device 100-1 (S521) and transmit the audio data received from the first display device 100-1, to the audio output device 500 (S523).

The shared image may be the same as an image that is previously displayed by the first display device 100-1.

The second display device 100-2 may transmit the audio data received from the first display device 100-1, to the audio output device 500 according to handover.

The second display device 100-2 may receive the image data received from the first display device 100-1 and transmit the audio data received from the first display device 100-1, to the audio output device 500 while displaying the shared image based on the image data.

The audio output device 500 may output audio based on the audio data received from the second display device 100-2 (S525).

A user who wears the audio output device 500 watches the image displayed on the first display device 100-1, and even if the user moves to the second display device 100-2, the user may receive an image and audio seamlessly.

FIG. 9 is a diagram for explaining a scenario for performing handover according to an embodiment of the present disclosure.

Referring to FIG. 9, the user currently listens to audio transmitted from the first display device 100-1 through the audio output device 500 while watching an image through the first display device 100-1 in a state of wearing the audio output device 500.

The first display device 100-1 may obtain a screen connection command for connecting a screen to the second display device 100-2.

The first display device 100-1 may determine whether the current situation is a handover situation according to the screen connection command.

When determining that the current situation is the handover the first display device 100-1 may terminate Bluetooth connection with the audio output device 500. The audio output device 500 may switch a mode thereof into a pairing mode from a connected mode according to the connection termination command received from the first display device 100-1.

The pairing mode may be a mode indicating a state in which it is possible to perform Bluetooth connection with another device.

The second display device 100-2 may perform Bluetooth connection with the audio output device 500 when the audio output device 500 moves to an adjacent location and connection is possible.

The second display device 100-2 may display an image based on the image data received from the first display device 100-1 and transmit the image data received from the first display device 100-1, to the audio output device 500.

The user may be provided with an image and audio from the second display device 100-2 in the same way without a separate additional process as an effect of receiving an image and audio through the first display device 100-1.

The user may receive an image and audio according to automatic handover seamlessly to largely improve user experience.

The first display device 100-1 may determine handover with the audio output device 500 according to the first RSSI.

When the first RSSI does not change despite receiving the screen connection command, the first display device 100-1 may determine that the audio output device 500 does not move and may not perform handover.

An RSSI may be determined depending on presence or absence of other objects nearby in addition to a distance between devices.

When the RSSI is changed to a reference value or more, the first display device 100-1 may determine handover.

For example, when the first RSSI is reduced to the reference value or more and the second RSSI is increased to the first reference or more, the first display device 100-1 may perform handover.

Whether to apply an embodiment of the present disclosure may be checked using the following method.

When an image displayed on the first display device 100-1 is displayed on the second display device 100-2 while the user receives an image and audio through the first display device 100-1, if a device connected to the audio output device 500 is changed (handover) to the second display device 100-2 from the first display device 100-1, it may be seen that the embodiment of the present disclosure is applied.

After handover, when sound setting information of the audio output device 500, checked by the second display device 100-2, is changed in the same way as in the first display device 100-1, it may be seen that the embodiment of the present disclosure is applied.

According to an embodiment of the present disclosure, the above-described method can be implemented as a processor-readable code in a medium on which a program is recorded. Examples of media readable by the processor include ROM, RAM, CD-ROM, magnetic tape, floppy disk, optical data storage, and the like.

The display device described above is not limited to the configuration and method of the above-described embodiments, but the above embodiments may be configured by selectively combining all or part of each embodiment so that various modifications can be made.

What is claimed is:

1. A display device comprising:
a display;
a Bluetooth communication circuit configured to communicate with an audio output device through Bluetooth;
a WiFi circuit configured to WiFi communicate with an external device; and
a controller configured to obtain a screen link command while transmitting audio data to the audio output device through the Bluetooth communication circuit, determine whether to perform handover to switch Bluetooth connection with the audio output device to the external device depending on the obtained screen link command, and stop connection with the audio output device based on determining to perform the handover.

2. The display device of claim 1, wherein the controller is configured to display a pop-up window for the handover on the display based on the screen link command being obtained, and perform the handover based on a confirm command being received through the pop-up window.

3. The display device of claim 1, wherein the controller is configured to obtain a first received signal strength indicator (RSSI) between the audio output device and the display device and a second RSSI between the audio output device and the external device, and
perform the handover when the second RSSI is greater than the first RSSI.

4. The display device of claim 1, wherein the controller is configured to determine whether to perform the handover based on connection availability information received from the external device.

5. The display device of claim 4, wherein the controller is configured to transmit information of the audio output device to the external device through the WiFi circuit, receive the connection availability information from the external device through the WiFi circuit, and perform the handover based on the connection availability information indicating a connectable state with the audio output device.

6. The display device of claim 5, wherein the connection availability information includes information indicating that a number of audio output devices connected to the external device is less than a limit of Bluetooth devices.

7. The display device of claim 1, wherein, based on that the handover is determined to be performed and is not capable of being performed, the controller is configured to display a guide for guidance of movement of the audio output device to a location of the external device, on the display.

8. The display device of claim 1, wherein the controller is configured to display a guide for guidance of movement of the audio output device to a location of the external device upon receiving the screen link command.

9. The display device of claim 1, wherein the controller is configured to transmit voice setting information for the audio output device to the external device upon determining to perform the handover, and
the voice setting information includes one or more of voice effect information, audio delay information, or audio volume information of the audio output device.

10. The display device of claim 9, wherein the controller is configured to transmit a setting command requesting voice setting for the audio output device to the external device along with the voice setting information, based on the voice setting information.

11. An operating method of a display device, the method comprising:
obtaining a screen link command while transmitting audio data to an audio output device through a Bluetooth communication circuit;
determining whether to perform handover to switch Bluetooth connection with the audio output device to the external device depending on the obtained screen link command; and
stopping connection with the audio output device based on determining to perform the handover.

12. The method of claim 11, further comprising:
displaying a pop-up window for the handover on the display based on the screen link command being obtained; and
performing the handover based on a confirm command being received through the pop-up window.

13. The method of claim 11, further comprising:
obtaining a first received signal strength indicator (RSSI) between the audio output device and the display device and a second RSSI between the audio output device and the external device; and
performing the handover when the second RSSI is greater than the first RSSI.

14. The method of claim 11, wherein the determining includes determining whether to perform the handover based on connection availability information received from the external device.

15. The method of claim 14, further comprising:
transmitting information of the audio output device to the external device;
receiving the connection availability information from the external device; and
performing the handover based on the connection availability information indicating a connectable state with the audio output device.

16. The method of claim 15, wherein the connection availability information includes information indicating that a number of audio output devices connected to the external device is less than a limit of Bluetooth devices.

17. The method of claim 11, further comprising: based on that the handover is determined to be performed and is not capable of being performed, displaying a guide for guidance of movement of the audio output device to a location of the external device.

18. The method of claim 11, further comprising displaying a guide for guidance of movement of the audio output device to a location of the external device upon receiving the screen link command.

19. The method of claim 11, further comprising transmitting voice setting information for the audio output device to the external device upon determining to perform the handover
wherein the voice setting information includes one or more of voice effect information, audio delay information, or audio volume information of the audio output device.

20. The method of claim 19, further comprising transmitting a setting command requesting voice setting for the audio output device to the external device along with the voice setting information, based on the voice setting information.
